(19) United States
(12) Patent Application Publication
(10) Pub. No.: US 2026/0065887 A1
(43) Pub. Date: Mar. 5, 2026

(54) INSULATION COMPONENT MANUFACTURING METHOD AND FLOW-TIGHT, LIGHT-WEIGHT INSULATION COMPONENT FOR VEHICLES

(71) Applicant: NVH CZECH S.R.O., Ceska Lipa - Dobranov (CZ)

(72) Inventors: Norbert Nicolai, Schermbeck (DE); Wonku Lee, Suwon, Gyunggi-Do (KR)

(21) Appl. No.: 19/105,811

(22) PCT Filed: Jun. 21, 2023
(86) PCT No.: PCT/DE2023/100467

§ 371 Date: Feb. 23, 2025

(30) Foreign Application Priority Data
Aug. 22, 2022 (DE) 10 2022 121 174.6

(51) Int. Cl. G10K 11/168; B29C 51/10; B29C 51/14; B29C 51/42; B29K 105/08; B29L 31/30; B32B 5/02; B32B 27/12; B32B 37/06; D06N 7/00

(52) U.S. Cl. CPC G10K 11/168; B29C 51/10; B29C 51/145; B29C 51/424; B32B 5/022; B32B 27/12; B32B 37/06; D06N 7/0081; B29K 2105/0854; B29K 2995/0002; B29K 2995/0063; B29K 2995/0067; B29K 2995/0097; B29L 2031/30; B32B 2307/72; B32B 2307/7242; B32B 2307/7376; B32B 2605/08; D06N 2211/263

(57) ABSTRACT

An insulation component manufacturing method for manufacturing flow-tight, light-weight, sustainable insulation components for vehicles, the insulation component having at least one tufted textile top cloth, a film as the steam-and air-tight flow-tight layer and an absorber layer from a nonwoven having fibers that run vertically upwards relative to the surface, and is manufactured by means of at least one steam vacuum tool. Also, a flow-tight, light-weight, sustainable insulation component for vehicles.

The invention relates to an insulation component manufacturing method for producing flow-tight, lightweight insulation components for vehicles, wherein insulation components comprise a textile upper material, a flow-tight layer and an absorber layer made of a VON nonwoven with fibers that are predominantly perpendicular to the surface.

Furthermore, the invention relates to a flow-tight, lightweight, sustainable insulation component for vehicles.

Insulation components, such as floor coverings, side panels and trunk linings in vehicles, generally have a structure consisting of an upper layer, a carrier layer and a spring or absorber layer. The structures differ depending on the application, vehicle class and manufacturer. There are also insulation components that lack one of the aforementioned layers.

The top layer/surface for floor coverings is almost always a carpet and can take on a wide range of forms. For example, top layers can be made of flat needle fleece, Dilour carpet or tuft in different surface weights and densities. The material used for needle fleece and Dilour carpets is mostly PET (polyethylene terephthalate) fibers. The fibers are embedded using latex and increasingly Co-PET.

The fibers of tufted carpets are mainly made of polyamide-6 (Perlon) or polyamide-66 (Nylon). However, PET fiber tufted carpets are now also commercially available. The carrier here is almost completely a PET material. The integration is done by EVA (ethylene vinyl acetate) or Co-PET.

The textile carriers currently in use are mainly mixed fiber nonwoven made of different plastics and cotton with a binder made of PP (polypropylene).

The heavy layers currently consist mostly of highly filled plastics, PE (polyethylene) or PP (polypropylene) based with EVA or a POE (polyolefin elastomer) with surface weights of 600 g/m² to several kg/m².

The springs or absorbers are usually either PUR (polyurethane) foam or fiber nonwoven, preferably made of PET fibers or mixed fibers with a Co-PET fiber bond.

The use of very different materials in insulation components, such as polar materials like PET, Co-PET, PA (polyamides), EVA on the one hand and completely non-polar materials like PE or PP on the other, which do not adhere but only allow a geometric coupling, currently make economical recycling difficult.

Recycling floor coverings with a PE- or PP-based heavy layer and a foam absorber is currently uneconomical and any production waste is not reused.

Floor coverings as components in which the upper carpet material and backing are separate from the insulation are primarily limited to nonwoven insulation and acoustically open carpets.

Foam insulation is almost always used as compact components, in which the upper carpet material and the carrier are rigidly and rigidly connected to the insulation. The upper material and the insulation can also be glued together.

For components with foam insulation, the foam is applied directly to the shaped upper material with the carrier. In this case, the upper material is or can be cut after foaming. Face fabrics with a carrier are heated, formed, cooled and then cut on a forming machine. With textile carriers, heating is usually done by contact heating, whereas with heavy layers it is mainly done by infrared radiation.

A layer structure and the sound insulation for floor coverings of vehicles produced therewith, having an acoustically effective layer, are known from the prior art from DE 39 05 607 A1, the principal structure of which consists of a layer of sound-absorbing material, which is provided with a foam backing, follows a visible surface that has been needled or tufted onto a surface fabric.

EP 0 453 877 A1 describes a process for manufacturing multifunctional trim parts, for example in the form of a spring-mass system. By the directed application of pressure and the effect of temperature, two compressible layers, such as nonwovens, separated by a barrier layer, are changed in density in opposite directions in a single operation in such a way that they form a spring-mass system and can be used as sound-insulating, multifunctional trim parts, for example in motor vehicles.

DE 199 60 945 A1 describes a floor covering for motor vehicles, essentially consisting of a carpet layer, a sound insulation layer arranged thereunder and a soft foam layer. Without impairing the acoustic effectiveness, an extremely low surface mass is achieved wherein the sound insulation is essentially formed by a two-layer nonwoven.

In addition, DE 103 60 427 A1 discloses a sound-reducing surface element with improved sound insulation and sound absorption properties, which has a heavy layer, a light layer, which form a mass-spring system, and a first nonwoven layer attached to the heavy layer by needling on the side opposite the light layer. The heavy layer has through-holes that are filled with the nonwoven material of the first nonwoven layer by needling, so that a high level of damping of structure-borne sound, i.e. a high loss factor, is ensured even over a long period of time.

DE 103 60 427 A1 also describes an acoustically effective molded automotive carpet component having a textile, air-permeable carrier layer, pile threads incorporated into the carrier layer, a barrier layer glued to the lower loops of the pile threads, and a foam back foamed onto the barrier layer, and a method for manufacturing such a molded carpet. In order to provide a molded carpet of this type, which has a high airborne sound-absorbing effect at a low weight and reduced costs, it is proposed that, instead of a sealing or heavy layer film, a fine-fiber needle mat is used as a barrier layer against foam penetration, wherein the needle fleece is made of chemical fibers with a fineness of less than 6.7 dtex and bicomponent hot-melt adhesive fibers and has a weight per unit area in the range from 600 to 900 g/m2.

DE 20 2012 004 594 U1 discloses a motor vehicle part for a motor vehicle, wherein the wear layer consists of polyethylene terephthalate yarns and/or fibers, a backing layer, if present, consists of polyethylene terephthalate and/or a copolymeric polyethylene terephthalate, a first adhesive layer, which may be present, consists of an adhesive based on polyethylene terephthalate, the adhesive layer (middle layer) consists of an adhesive based on polyethylene terephthalate, the back layer consists of a nonwoven or woven fabric based on polyethylene terephthalate and the insulation layer consists of PET/Co-PET fibers.

A method for manufacturing components that are at least two-layered and components manufactured in this way, themselves as an absorptive trim in the interior and/or luggage compartment or for floor trim in motor vehicles, comprising an upper material and an absorber, is known from WO 2014/082 869 A1. A single-sided shaped absorber material and a face fabric are placed in a steam/vacuum tool and the face fabric is shaped, a binder is activated in the backing fabric and the face fabric and backing fabric are bonded to one another.

DE 10 2021 101 905 A1 discloses a fiber composite component, in particular for an acoustically damping vehicle interior trim, which is made from a fiber material pressed in a mold to form a molded part under the supply of heat, characterized in that the molded part is made from fiber material in the form of fiber balls.

U.S. Pat. No. 5,076,870 A discloses an improved carpet, an improved method for manufacturing a carpet and an improved method for attaching a carpet to a motor vehicle door panel. The improved carpet comprises an outer woven polypropylene pile layer, an inner non-woven polypropylene layer and a central recycled rubber layer. The carpet is formed by extruding a molten mixture of rubber and polypropylene particles into a hot central web and then adhering a woven polypropylene layer to the top side of the hot web and an unwoven polypropylene layer to the bottom side of the hot web. The carpet is attached to the lower portion of an automobile door panel by heating the lower portion of the door panel with hot air until the panel is tacky and then pressing the carpet of the invention downwardly against the tacky surface of the door panel to form a rigid welded joint between the carpet and the panel. Alternatively, the bonding of the carpet and the panel can be achieved by applying ultrasonic energy through the door panel to the interface between the door panel and the carpet.

DE 10 2004 032 925 A1 discloses a sound insulation system for use in a vehicle comprising a layer of fibrous cushioning material having a first surface and an opposing second surface. The first surface includes a plurality of spaced-apart indentations. The second surface includes a substantially flat portion extending across two adjacent indentations. The plurality of recesses is configured to define a plurality of cavities when the sound insulation system is mounted in the vehicle, thereby increasing the acoustic performance of the sound insulation system.

In addition, DE 92 00 439 U1 describes a crush-resistant, rigid molding, in particular for the floor area in the passenger compartment of automobiles, comprising a stable substructure layer made of a rot-resistant first plastic material and a decorative layer made of a second plastic material or natural material and arranged on the visible side over the substructure layer, and optionally one or more sealing layers made of further plastic materials and arranged between the substructure layer and decorative layer and/or on the rear side of the substructure layer, all layers being laminated to form a multilayer structure, characterized in that the substructure layer has a fibrous component and a thermoplastic binder component distributed therein, the proportion of which is suitable for producing the required rigidity of the molded part.

A folded nonwoven product and a method for producing such a product, which is particularly suitable for various applications in the automotive sector, are known from U.S. Pat. No. 6,534,145 B1. The product is formed from a fibrous mat, the fibers in each fold extending substantially vertically when the mat is oriented horizontally. The pleated nonwoven mat can be used to make a variety of products, including automotive carpets and mats, trim pieces, trunk liners, cushioning, engine compartment liners and sound deadening materials. Further embodiments of the invention utilize a split folded product that constitutes a unique automotive textile, carpet or other cushioning product and a unitary carpet and under-cushioning product that utilizes the invention's folded product.

DE 11 2012 005 205 T5 discloses an interior molding material for a vehicle, wherein a compression-molded decorative layer facing the direction of the vehicle interior and a buffer material layer facing the direction of a body panel are at least compression molded, wherein the buffer material layer is formed by compression molding a fiber structure in which fibers are aligned in the thickness direction. A convex portion corresponding to a convex surface of the body panel is formed on the decorative layer. A compression-molded portion is formed on the buffer material layer, which is set back from the convex surface of the body panel in the direction of the convex portion of the decorative layer, so that the thickness is 0.03 to 0.5 times the thickness of a surrounding area and the density is higher than that of the surrounding area.

The DE 10 2021 108 602 A1 describes a one-step process for manufacturing a panel and in particular a floor panel for a motor vehicle with insulation made of fiber/absorption nonwoven, as well as optionally further absorptive layers, which may differ in their mechanical-physical and acoustic properties in zones (partially) over the surface and thickness of the insulation. The focus is on nonwoven structures whose fiber alignment/fiber orientation is perpendicular to the surface/wear layer of the floor covering.

The problems in the state of the art are essentially based on two problem areas.

Firstly, foam is used as insulation material for lightweight acoustic components. It is difficult to recycle these components economically, or to recycle them at all.

On the other hand, components with conventional nonwoven insulation are significantly heavier due to their mechanical characteristics.

With a few exceptions, such components are manufactured in a two-stage process. The top cloth with or without carrier and the nonwoven insulation are formed separately. In a second step, the foam is foamed onto the deformed top cloth.

The present invention is based on the task of providing a method for manufacturing an insulation component for vehicles as well as an insulation component for vehicles, by means of which a significantly lower weight can be realized compared to conventionally manufactured insulation components with specified mechanical properties.

In addition, the process should make it possible to form, join and consolidate a compact component in which the carpet outer fabric and carrier are rigidly connected directly to the insulation in a single step.

Furthermore, the present invention should make it possible to economically reintegrate production waste from the manufacture of insulation components into the production process by means of suitable material combinations.

Another aspect is the sustainability of the process and the component.

This task is solved with an insulation component manufacturing method according to the main claim and a flow-tight, lightweight insulation component for vehicles according to the subsidiary claim.

The insulation component manufacturing method for manufacturing flowtight, lightweight, also sustainable insulation components for vehicles, wherein the insulation component comprises at least one textile top cloth with a pile, a film as a vapor-tight and airtight, flowtight layer and an absorber layer of a VON nonwoven with fibers predominantly perpendicular to the surface and is manufactured with at least one steam-vacuum tool, has at least the following steps:
a. providing the textile top cloth with a pile, wherein the pile faces upwards in a first variant 1 or downwards in a second variant 2 and initially downwards in a third variant 3 and upwards in the further process;
   when the textile top cloth with pile is oriented upwards in variant 1:
b1. applying the film to the textile top cloth from below and heating with an infrared heater from below forming a textile top cloth with film from below;
c1. preparing and placing the nonwoven in the steam-vacuum tool and then placing and inserting the textile top cloth with film from below onto the nonwoven in the steam-vacuum tool; or
b2. applying a carrier from below to the textile top cloth and heating it with a contact heater and pressing it to form textile top cloth with pressed carrier and applying the film from below;
c2. providing and inserting the nonwoven into the steam-vacuum tool and then inserting and depositing the textile top cloth with carrier from below onto the nonwoven in the steam-vacuum tool; or
b3. applying a carrier from below to the textile top cloth and applying a film from below to the carrier and heating with a contact heater;
c3. providing and placing and inserting the nonwoven in the steam-vacuum tool and depositing the textile top cloth, with the pile facing upwards, with the carrier placed underneath and the film placed underneath from above on the nonwoven in the steam-vacuum tool;
   with the pile from a. facing downwards in variant 2:
b4. applying the film from above to the textile top cloth and heating with an infrared heater from above forming a textile top cloth with film from above;
c4. providing and applying the nonwoven from above to the textile top cloth with film from above and then placing and inserting the textile top cloth with film from above with the nonwoven placed on top into the steam vacuum tool; or
b5. applying a carrier from above to the textile top cloth and heating with a contact heater and pressing to form textile top cloth with pressed carrier and applying the film from above;
c5. providing and applying the nonwoven from above onto the textile top cloth with carrier from above and then inserting and depositing the textile top cloth with carrier from above with the VON nonwoven placed on top into the steam vacuum tool; or
b6. applying a carrier to the textile top cloth from above and then applying a film to the carrier from above and heating with a contact heater;
c6. providing and applying the nonwoven from above onto the film on the structure consisting of film and the carrier, with the carrier on the top cloth with pile facing downwards and subsequent or simultaneous insertion into the steam-vacuum tool; with the orientation of the textile top cloth with pile first downwards and then upwards in variant 3:
b7. applying a carrier to the textile top cloth from above, with the pile facing downwards, and applying a film to the carrier and heating with a contact heater to form textile top cloth with carrier and film;
   after heating, turning the structure of textile top cloth with carrier and film arranged thereon, with the pile of the top cloth facing upwards after turning;
c7. providing and inserting the nonwoven into the steam-vacuum tool and then inserting and depositing the textile top cloth with carrier and film, with the pile of the top cloth facing upwards, onto the nonwoven located in the steam-vacuum tool;
d. closing the steam-vacuum tool and applying steam from the back side of the textile top cloth and applying vacuum from the pile side of the textile top cloth and shaping to produce the component in its final contour and/or final shape and solidifying the component;
e. opening the steam-vacuum tool and removing the component and depositing and/or further processing for cooling as required and/or punching the component into its final shape.

In addition, in individual processes, in particular when orienting the pile from a. downwards in variant 2 in step b4, a heavy layer can also be applied before applying the film.

Also, in a preferred variant, the resulting punching waste can be reused during contour punching, whereby the punching waste is at least partially used for the nonwoven and/or the heavy layer and/or the textile carrier. This results in particularly sustainable components and a correspondingly sustainable process is carried out.

In addition, the aspect of sustainability is also ensured by the process and the components produced. The elements can be easily recycled later on.

In particular embodiments, the heating in step bx. can in particular introduce heat from above or from below or even from both sides. In particular, the contact heating can also act from above and/or from the side of the film. Furthermore, the heating in steps b1. and/or b2. and/or b3. and/or b4. and/or b5. and/or b6. and/or b7 can alternatively and/or additionally be carried out with contact heating or non-contact heating or infrared heating. It is also possible to choose between contact heating, non-contact heating and infrared heating.

In particular, the additional carrier can consist of mixed fiber nonwoven and / or torn punching waste laid into nonwoven.

The heavy layer can consist of chemically compatible materials and/or punching waste, whereby a mixture of chemically compatible materials and punching waste is the preferred embodiment.

The flowtight, lightweight, sustainable insulation component for vehicles is characterized by:
the insulation component has at least the following layers in a successive layer structure:
a textile top cloth with a pile,
a textile carrier or a heavy layer,
a film as a vapor and airtight, flowtight layer and
an absorber layer made of a VON nonwoven with fibers standing predominantly perpendicular to the surface,
   wherein
the layers are bonded together,
the top cloth consists of a textile fabric, needle-punched nonwoven, dilour, tufted carpets and/or flexible woven or knitted fabric,
   wherein
the materials used, such as fiber, weave and carrier in the case of tufted carpets are compatible with each other to such an extent that
that they form a deformable surface element after tearing and renewed nonwoven formation
   and/or
all components of the materials used are fully bonded as additives in a heavy layer,
the textile carrier fully or partially reinforces the top cloth and consists of a mixed fiber nonwoven made of compatible materials and/or PET fibers and/or CoPET bonding and/or recycled punching waste,
the heavy layer is applied over the entire surface or partially, wherein the heavy layer consists of plastics and/or inorganic fillers and/or shredded punching waste and/or CoPET and/or EVA,
the plastics used can be mixed and/or bonded with one another, wherein these are selected from: PET, CoPET, EVA, PA,
the film consists of PA and/or PET and/or copolymers thereof, and
the insulation component is produced without waste, wherein die-cutting waste arising during production is completely reused.

The insulation component can be manufactured in particular by the insulation component manufacturing method according to the invention.

The film can be arranged as a vapor-and air-tight flow-tight layer between two adhesive layers and/or consist of materials that are stable at the vapor temperature.

Preferably, provided and/or additional adhesive and/or adhesive layers can be formed as multilayer films with the film as a vapor-and air-tight flow-tight layer in the middle and/or as cover layers and/or can be provided on the top cloth and on the nonwoven and/or can be selected as material for the adhesive/adhesive films CoPET and/or EVA.

An exemplary structure comprises a vapor-tight PA film in the middle and Co-PET or EVA adhesive films as top layers, wherein the structure is attached to the carpet face fabric on the one hand and to the nonwoven on the other.

According to the invention, the absorber is formed from a nonwoven having fibers perpendicular to the surface.

Advantageously, the nonwoven can have a total thickness of 4 to 60 mm, preferably 20 to 50 mm.

The nonwoven of the absorber layer can also, in particular, have both a constant density of 10 to 130 g/l, preferably between 20 and 50 g/l, or, over the length of the nonwoven of the absorber layer, areas with different densities in the density range from 20 g/l to 50 g/l.

In addition, one nonwoven side of the insulation component can be placed on a vehicle body, wherein this side is nubby or, preferably, the nonwoven insulation can be structured on the body side.

At the same time as the textile top cloth is being heated, the carrier can be compressed when the nonwoven is formed with an additional carrier.

It is also possible that all plastics used in an insulation component according to the invention can be mixed and/or glued together.

The final contour of the insulation component can be structured or unstructured or structured in sections and unstructured in sections.

When carrying out the insulation component manufacturing method, the nonwoven and textile top cloth can be introduced into the steam vacuum tool at different times by means of pick-and-place technology and/or robot technology.

This means that the insulation component manufacturing method can be automated or partially automated and, for example, partial application of the textile carrier, heavy layer or nonwoven can be carried out by means of robots.

It is also possible, for example, to use a clamping device to cycle the component structure, starting with the top cloth, so that it is transported to the individual stations and finally deposited for cooling.

The fibers of the insulation component can be PET fibers or mixed fibers, preferably plastic fibers.

The automotive component known from DE 20 2012 004 594 U1 has a “single-material” material composition, but despite the few different materials used, it offers no advantages over the prior art for a textile recycling solution, it cannot be used for carpets with a heavy layer, and it is not possible to reuse the production waste to produce fibers due to the Co-PET used.

With the manufacturing method for insulation components described here, it will be possible to use material combinations that allow all waste to be economically re-integrated into the production process.

The manufacturing method for the insulation component is designed in such a way that the top cloth is formed together with the carrier and the insulation into the final contour in a single step. For this purpose, all components of the floor covering, including the absorber made of fibers oriented perpendicular to the surface, a textile carrier or heavy layer, and a carpet top cloth, are placed in the tool, the absorber material is thermally bonded and, together with the top cloth and carrier, is shaped, joined and solidified into the final contour in a single step.

The production waste can preferably be shredded and reused in the component as aggregate for the heavy layer or completely for the carrier.

Compared to the prior art, the insulation component formed by the manufacturing method according to the invention has the same mechanical properties but up to 30% lower weight. Higher compressive strengths are achieved at the same density compared to conventional nonwovens or even foam. The properties of the nonwoven can be influenced by the fiber properties, such as fiber length, fiber diameter and crimp.

In addition, the production can be designed to be waste-free, since all punching waste can be reused in the insulation component. If the insulation components can no longer be used, for example in the case of end of life, they can be reused in textile or plastic technology.

In general, PET fibers, preferably from recycled bottles and Co-PET, are used as binders for needle fleece carpets of different qualities.

When the insulation component manufacturing method according to the invention is used, for example, tufted carpets made preferably of PET-G yarn, a PET carrier and Co-PET or EVA as a binder can be used.

In particular, a PET/Co-PET nonwoven can be used as a carrier for covering the textile top cloth. The mixing ratio of PET fiber to Co-PET binder is preferably 60% to 40% Co-PET binder fibers.

If there is sufficient punching waste from the process, this is torn open, re-laid as a nonwoven and reused in the production process. Nonwovens with a basis weight of 100 g/m² to 900 g/m² can be used as carriers, preferably 150 g/m² to 300 g/m².

The invention is described below with reference to the accompanying figures in the figure description, wherein these are intended to explain the invention and are not necessarily restrictive:

### THE FOLLOWING SHOWS:

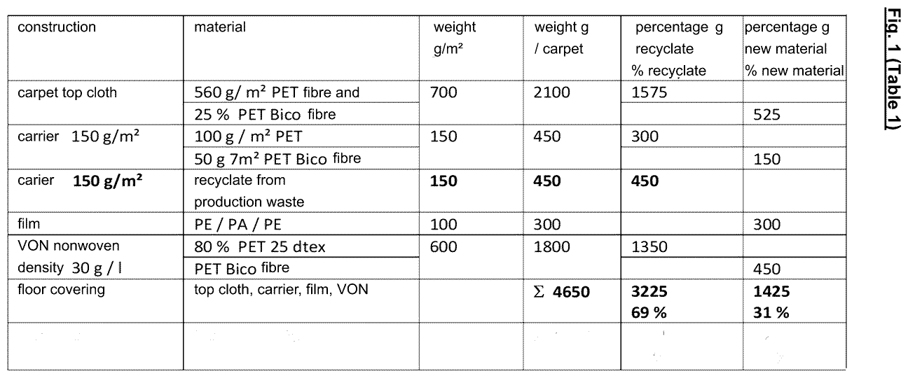

FIG. 1 a tabular overview of an exemplary composition of an insulation component with a 150 g/m3 carrier applied over the entire surface, manufactured using the insulation component manufacturing method according to the invention with and without the use of recyclate;

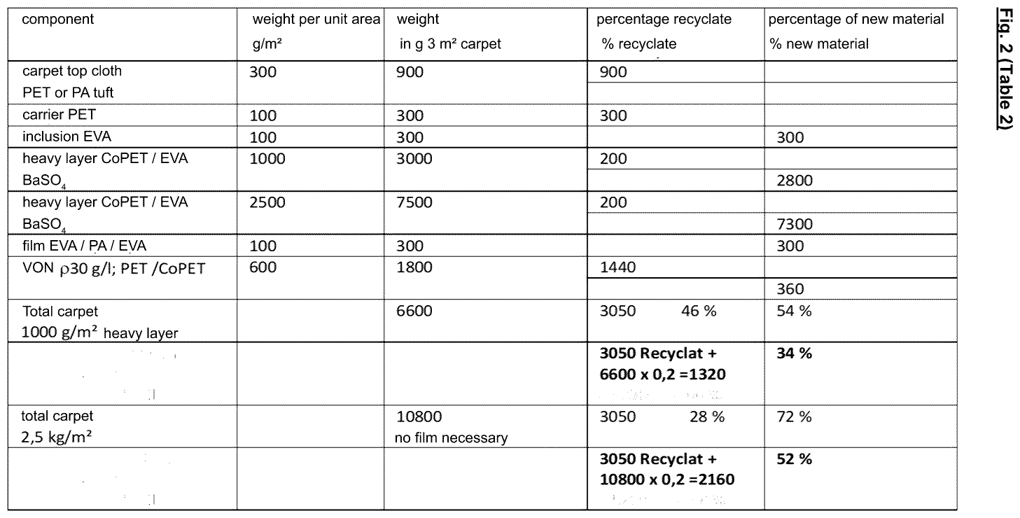

FIG. 2 tabular overview of an exemplary composition of two insulation components with different heavy-layer compositions manufactured using the insulation component manufacturing method according to the invention with different recyclate proportions;

FIG. 3 an exemplary point diagram showing an overview of the compressive strength of various fiber types as a function of density;

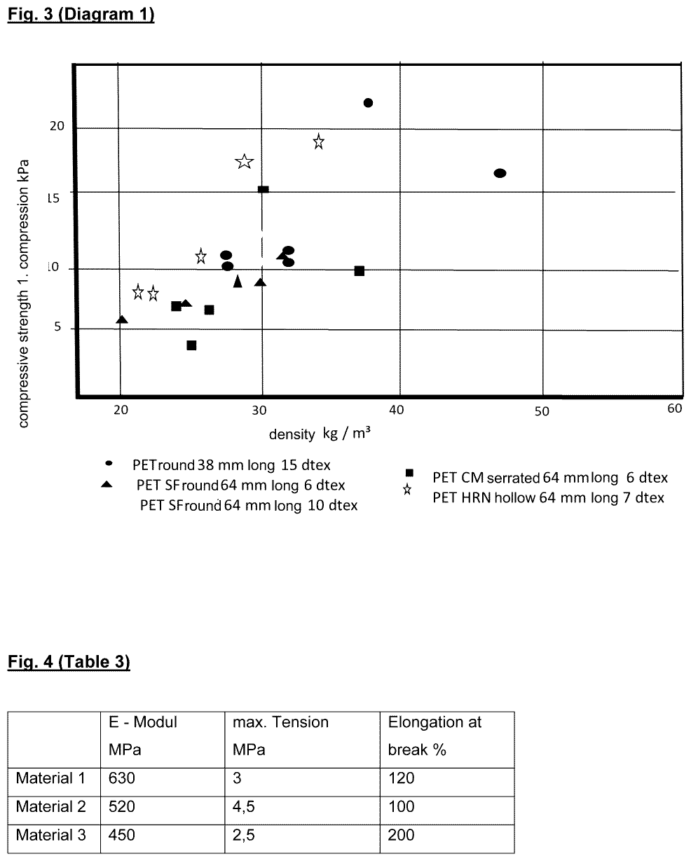

FIG. 4 an exemplary tabular overview of selected mechanical properties of heavy layers with three different fillings;

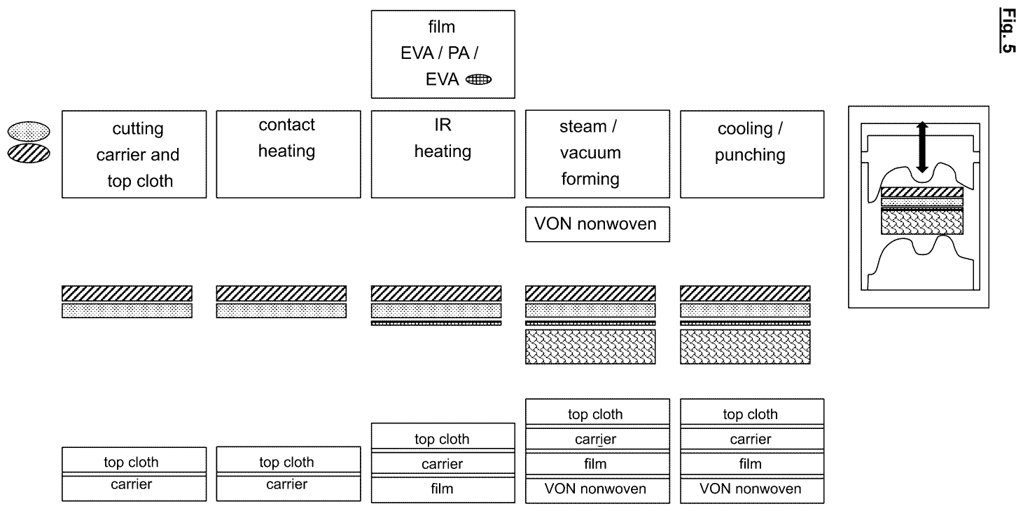

FIG. 5 an exemplary block diagram of the insulation component manufacturing method according to the invention with a textile top cloth with the pile side facing upwards and covered with an additional carrier or additional heavy layer;

FIG. 6 an exemplary block diagram of the insulation component manufacturing method according to the invention with a textile top cloth with the pile side facing downwards and covered with an additional carrier and

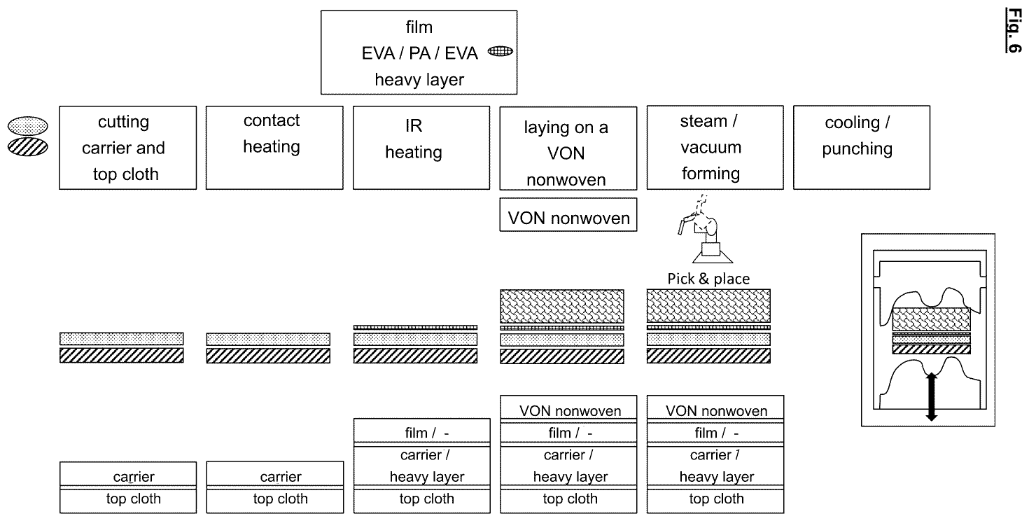

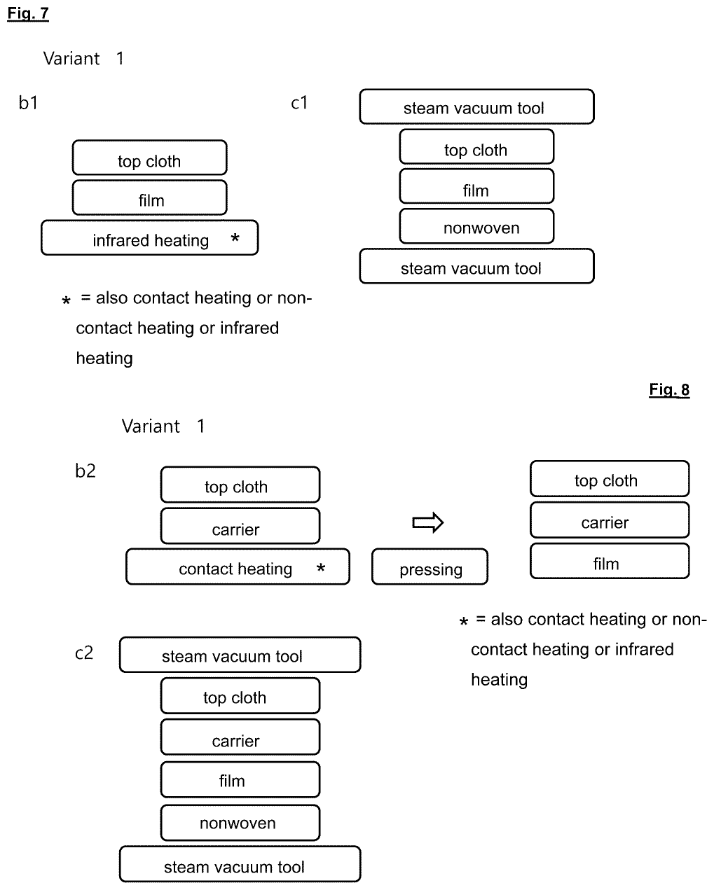

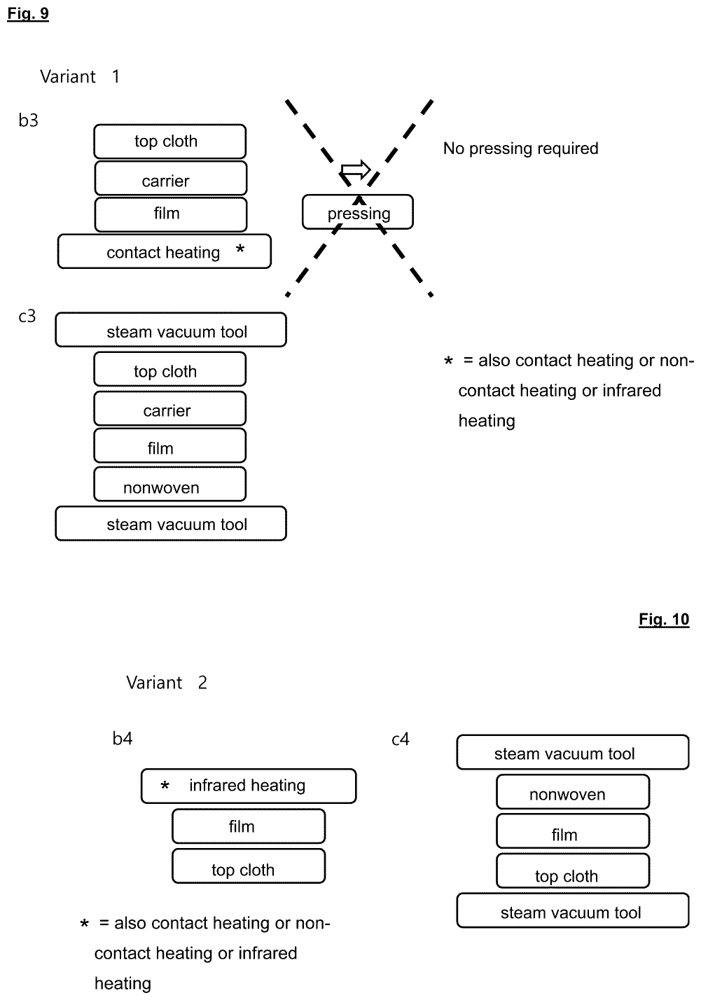

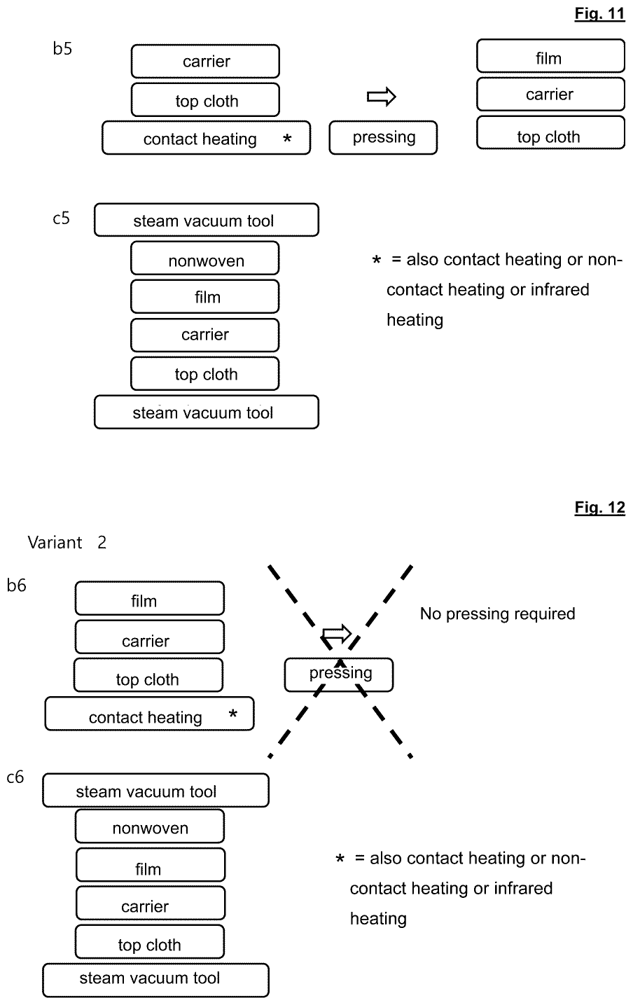

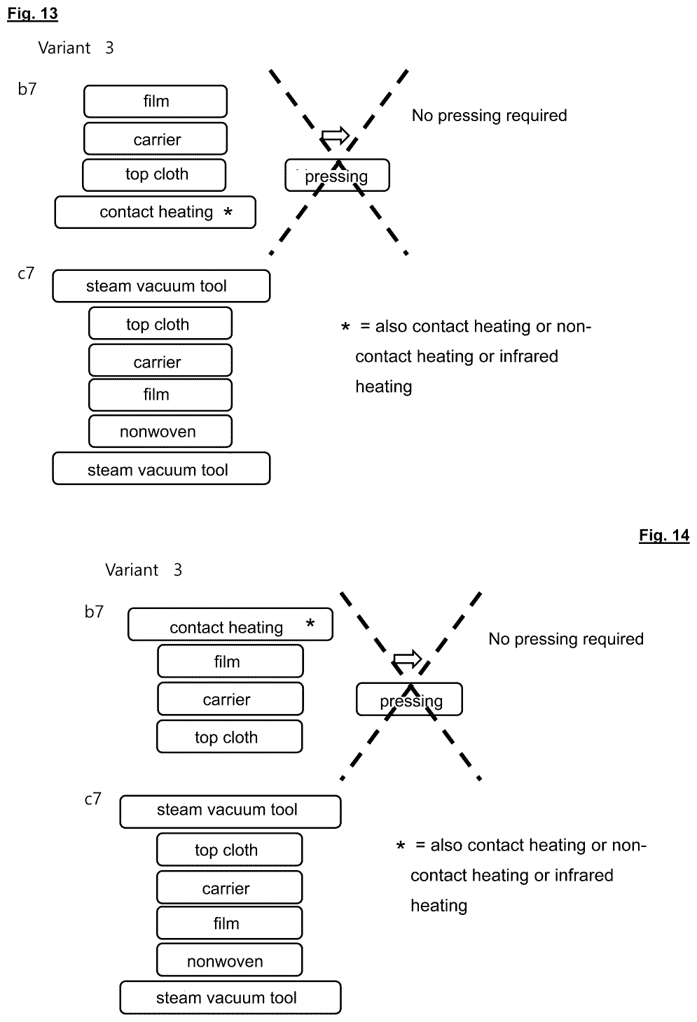

FIG. 7 to FIG. 14 the individual preferred basic design variants of the invention.

FIG. 1 shows a tabular overview of an exemplary composition of an insulation component with a 150 g/m3 carrier applied over the entire surface, manufactured using the insulation component manufacturing method according to the invention, with and without the use of recyclate.

The table shows that when recyclate is used for the 150 g/m3 carrier applied over the entire surface, the percentage of new material required for the insulation component is reduced from 31% to 27% for the exemplary composition.

Of course, it is also possible to use recyclate for only part of the carrier material and to provide the carrier from a mixture of recyclate and new material.

However, a textile carrier has disadvantages for higher surface weights of the carrier. Depending on the shape, binder fiber content and compression, the density of a textile carrier is 0.6 g/cm³ to 0.9 g/cm³, which means that compared to a heavy layer, the nonwoven carrier is at least twice as thick for the same surface weight. At high compression, the carrier is very stiff and acoustically less effective than a heavy layer. A heavy layer is the better solution for higher surface weights.

Almost all heavy layers used consist of an inorganic filler, a stiffer PE or PP-based plastic and a soft plastic such as POE or EVA. Recycling punching waste as an additive for a heavy layer with the aforementioned structure worsens the deformation behavior of the heavy layer to such an extent that the heavy layer cracks during the production process.

If the structure of the heavy layer is modified so that an inorganic filler and a soft and a harder co-polyester or, in another version, an EVA and a co-PET are present, the flexibility of the heavy layer is significantly better and the problem of tearing during the production process is avoided.

FIG. 2 shows a tabular overview of an exemplary composition of two insulation components with different heavy layer compositions, manufactured using the insulation component manufacturing method according to the invention with different recyclate proportions.

The table clearly shows, by way of example, that different advantages arise depending on the composition. For example, the insulation component with a heavy layer with a surface weight of 1 kg/m2 in the example has a recyclate percentage of 66%, while the insulation component with a heavy layer with a surface weight of 2.5 kg/m2 has a recyclate percentage of only 48%. On the other hand, the use of the heavy layer with a surface weight of 2.5 kg/m2 makes it possible to dispense with the film as a flow-proof layer.

The mechanical characteristics vary depending on the degree of filling of the heavy layer with inorganic material and shredded recyclate, as well as the percentage of different plastics.

In trials, an initial density of the nonwoven of the absorber layer of 20 to 30 g/l has proven to be sufficient. Depending on the component design, it is possible to compensate for differences in thickness by pressing or applying additional material. Wherein a mean density of 30 g/l to 50 g/l is achieved for the specific component. In a special design, the initial density of the nonwoven plates can be varied along their length.

FIG. 3 shows an example of a scatter diagram with an overview of the compressive strength of various types of fibers in kPa as a function of their density in kg/m3.

The scatter diagram shows various PET fibers with different lengths, shapes and finenesses.

FIG. 4 shows an example of a tabular overview of the mechanical properties of various materials. The tensile modulus, maximum stress and elongation at break of heavy-duty layers with different fillings were determined in a tensile test. It is clear from this that the materials have distinctly different mechanical properties. The materials are a heavy layer with a high filling level of chalk and punching waste (material 1), a heavy layer with a high filling level of punching waste (material 2) and a heavy layer with a low filling level of inorganic filler (material 3). At 200%, material 3 has by far the highest value for elongation at break. The materials 1 and 2 tear at 120% and 100% as the elongation at break value, even at significantly lower deformations.

FIG. 5 shows an exemplary block diagram of the insulation component manufacturing method according to the invention, with a textile top cloth with the pile side facing upwards and covered with an additional carrier or an additional heavy layer.

The following describes an example of an embodiment using a carrier: In a first step, the textile top cloth and a carrier are cut to size. Subsequently, the textile top material is covered with the additional carrier with the pile side facing upwards, wherein the carrier can be formed over the entire surface or partially and is formed in particular from mixed fiber nonwovens and/or torn punching waste that is laid to form a nonwoven. The textile top cloth and the carrier are heated in a contact heating system, wherein the carrier is compressed at the same time. In the next step, a multilayer film is applied as an adhesive film and a vapor-and air-tight layer to the structure of the textile top cloth and carrier. In this example, the film has the structure EVA/PA/EVA. After that, the absorber layer, i.e. the nonwoven with fibers perpendicular to the surface (VON nonwoven), is placed in the steam and vacuum tool either as a single blank or with additional partial inserts. The assembly consisting of the textile top cloth, carrier and multilayer film is then placed in the steam and vacuum tool. The individual parts can be inserted into the steam and vacuum tool preferably by means of pick and place technology. The tool is closed and steam is applied to the back of the textile top cloth, while a vacuum is drawn from the pile side of the textile top cloth. In this way, the nonwoven is consolidated starting from the textile top cloth and the component is formed into its final contour. In this step, the individual layers are rigidly bonded to one another. The steam introduced is sucked out by the vacuum. The component is then removed and placed in a cooling and calibrating tray for cooling. In this example, the resulting punching waste is collected, shredded and reused for nonwoven production so that it can be returned to the process as a carrier.

Of course, the process described here as an example can also be carried out entirely without a carrier. This then means in turn that the textile top cloth is heated by means of contact heating without the presence of a carrier and a subsequent applying of a flow-tight film directly on the textile top cloth takes place.

In another design variant, in which the textile top cloth is aligned with the pile side facing up, the textile top cloth can also be covered with a heavy layer. Such a heavy layer preferably consists of chemically compatible materials and can be covered with punching waste. When the textile top cloth is lined with a heavy layer, the textile top material is heated by means of infrared radiation. Applying a flow-tight layer in the form of a multilayer film is only necessary if the heavy layer itself does not form this when the textile top cloth is lined. The further steps for manufacturing the insulation component are carried out in accordance with the process already described with a carrier. Pick and place technology can also be used here. Only the processing of the punching waste differs in the further course, since in this case the punching waste can be returned to the process as an aggregate for the heavy layer after shredding.

Furthermore, it is also possible in all applications to form the textile top cloth fully or partially covered with a combination of carrier and heavy layer.

FIG. 6 shows an example block diagram of the insulation component manufacturing method according to the invention, with a textile top cloth with the pile side facing downwards and an additional carrier applied to it.

In a first step, the textile top cloth and a carrier are cut. Subsequently, the additional carrier is placed on the textile top material with the pile side facing downwards, wherein the carrier can be formed over the entire surface or partially and is formed in particular from mixed fiber nonwovens and/or torn punching waste that is laid to form a nonwoven. The textile top cloth and the carrier are heated in a contact heating system, wherein the carrier is compressed at the same time. In the next step, a multilayer film is applied to the structure of the textile top cloth and carrier as an adhesive film and a vapor-and air-tight layer. In this example, the film has the structure EVA/PA/EVA. Next, the absorber layer, i.e. the nonwoven with fibers perpendicular to the surface (VON nonwoven), is applied either as a single layer or with additional partial inserts to the structure of textile top cloth, carrier and multilayer film. The entire structure is then placed in a steam and vacuum tool. The tool is closed and steam is applied from the back of the textile top cloth and vacuum is applied from the pile side of the textile top cloth. In this way, the absorber layer is consolidated starting from the textile top cloth and the component is formed into its final contour. In this step, the individual layers are rigidly bonded to each other. The steam introduced is sucked out by the vacuum. The component is then removed and placed in a cooling and calibrating tray for cooling. In this example, the resulting punching waste is collected, shredded and used to produce new nonwoven, so that it can be returned to the process as a recyclate in the form of a carrier.

Of course, the process described here as an example can also be carried out entirely without a carrier. This then means in turn that the textile top cloth is heated by means of contact heating without the presence of a carrier and a subsequent applying of a flow-tight film directly on the textile top cloth takes place.

In another design variant, in which the textile top cloth is aligned with the pile side facing downwards, the textile top cloth can also be covered with a heavy layer. Such a heavy layer preferably consists of chemically compatible materials and punching waste can be added. When the textile top cloth is coated with a heavy layer, the textile top material is heated using infrared radiation. Applying a flow-tight layer in the form of a multilayer film is only necessary if the heavy layer itself does not form this when the textile top cloth is coated. The further steps for manufacturing the insulation component are carried out in accordance with the process already described with a carrier. Only the processing of the punching waste differs in the further course, since in this case the punching waste can be returned to the process as an aggregate for the heavy layer after crushing.

The FIG. 7 to FIG. 14 show the individual preferred basic design variants of the invention. In particular, reference is also made to the figures with the variants without pressing. These are not necessarily limiting design variants, but some of them may be particularly preferred. There are different advantages in the design variants, which, depending on the application, can enable significant reductions in process times. You can choose between contact heating, non-contact heating and infrared heating.

1. An insulation component manufacturing method for manufacturing flowtight, lightweight, also sustainable insulation components for vehicles, wherein the insulation component comprises at least
one textile top cloth with a pile,
a film as a vapor-tight and airtight, flowtight layer and
an absorber layer of a VON nonwoven with fibers predominantly perpendicular to the surface and is manufactured with at least one steam-vacuum tool, comprising at least the following steps:
a. providing the textile top cloth with a pile, wherein
the pile faces upwards in a first variant or downwards in a second variant and initially downwards in a third variant and upwards in the further process;
when the textile top cloth with pile from a. is oriented upwards according to the first variant
b1. applying the film to the textile top cloth from below and heating with an infrared heater from below forming a textile top cloth with film from below;
c1. preparing and placing the nonwoven in the steam-vacuum tool and then placing and inserting the textile top cloth with film from below onto the nonwoven in the steam-vacuum tool; or
b2. applying a carrier from below to the textile top cloth and heating it with a contact heater and pressing it to form textile top cloth with pressed carrier and applying the film from below;
c2. providing and inserting the nonwoven into the steam-vacuum tool and then inserting and depositing the textile top cloth with carrier from below onto the nonwoven in the steam-vacuum tool; or
b3. applying a carrier from below to the textile top cloth and applying a film from below to the carrier and heating with a contact heater;
c3. providing and placing and inserting the nonwoven in the steam-vacuum tool and inserting the textile top cloth, with the pile facing upwards, with the carrier placed underneath and the film placed underneath from above on the nonwoven in the steam-vacuum tool;
with the pile from a. facing downwards according to the second variant:
b4. applying the film from above to the textile top cloth and heating with an infrared heater from above forming a textile top cloth with film from above;
c4. providing and applying the nonwoven from above to the textile top cloth with film from above and then placing and inserting the textile top cloth with film from above with the nonwoven placed on top into the steam vacuum tool; or
b5. applying a carrier from above to the textile top cloth and heating with a contact heater and pressing to form textile top cloth with pressed carrier and applying the film from above;
c5. providing and applying the nonwoven from above onto the textile top cloth with carrier from above and then inserting and depositing the textile top cloth with carrier from above with the VON nonwoven placed on top into the steam vacuum tool; or
b6. applying a carrier to the textile top cloth from above and then applying a film to the carrier from above and heating with a contact heater;
c6. providing and applying the nonwoven from above onto the film on the structure consisting of film and the carrier, with the carrier on the top cloth with pile facing downwards and subsequent or simultaneous insertion into the steam-vacuum tool;
with the orientation of the textile top cloth with pile from a. first downwards and then upwards in the third variant:
b7. applying a carrier to the textile top cloth from above, with the pile facing downwards, and applying a film to the carrier and heating with a contact heater to form textile top cloth with carrier and film;
after heating, turning the structure of textile top cloth with carrier and film arranged thereon, with the pile of the top cloth facing upwards after turning;
c7. providing and inserting the nonwoven into the steam-vacuum tool and then inserting and depositing the textile top cloth with carrier and film, with the pile of the top cloth facing upwards, onto the nonwoven located in the steam-vacuum tool;
d. closing the steam-vacuum tool and applying steam from the back side of the textile top cloth and applying vacuum from the pile side of the textile top cloth and shaping to produce the component in its final contour and/or final shape and solidifying the component; and
e. opening the steam-vacuum tool and removing the component and depositing and/or further processing for cooling as required and/or punching the component into its final shape.

2. The manufacturing method according to claim 1, wherein the heating in at least one of steps b1, b2, b3, b4, b5, b6. And b7 can alternatively and/or additionally be carried out with contact heating or non-contact heating or infrared heating.

3. The manufacturing method according to claim 1, wherein when orienting the pile from a. downwards in the second variant in step b4. a heavy layer is applied before applying the film.

4. The manufacturing method according to claim 1, wherein resulting punching waste is reused during contour punching, whereby the punching waste is at least partially used for at least one of the nonwoven, the heavy layer and the textile carrier.

5. The manufacturing method according to claim 4, wherein the additional carrier consists of mixed fiber nonwoven and/or torn punching waste laid into nonwoven.

6. The manufacturing method according to claim 4, wherein the heavy layer consists of chemically compatible materials and/or punching waste.

7. A flowtight, lightweight, sustainable insulation component for vehicles, wherein
the insulation component has at least the following layers in a successive layer structure:
a textile top cloth with a pile,
a textile carrier or a heavy layer,
a film as a vapor and airtight, flow-tight layer and
an absorber layer made of a VON nonwoven with fibers standing predominantly perpendicular to the surface, wherein
the layers are bonded together,
the top cloth consists of a textile fabric, needle-punched nonwoven, dilour, tufted carpets and/or flexible woven or knitted fabric, wherein
the materials used, are compatible with each other to such an extent that
they form a deformable surface element after tearing and renewed nonwoven formation and/or
all components of the materials used are fully bonded as additives in a heavy layer,
the textile carrier fully or partially reinforces the top cloth and consists of a mixed fiber nonwoven made of compatible materials and/or PET fibers and/or CoPET bonding and/or recycled punching waste,
the heavy layer is applied over the entire surface or partially, wherein the heavy layer consists of plastics and/or inorganic fillers and/or shredded punching waste and/or CoPET and/or EVA,
the plastics used are mixed and/or bonded with one another, wherein these are selected from: PET, CoPET, EVA, and PA,
the film consists of PA and/or PET and/or copolymers thereof, and
the insulation component is produced without waste, wherein die-cutting waste arising during production is completely reused.

8. The insulation component according to claim 7, wherein the insulation component can be manufactured in particular by the insulation component manufacturing method according to the invention.

9. The insulation component according to claim 7, wherein the film can be arranged as a vapor-and airtight flowtight layer between two adhesive layers.

10. The insulation component according to claim 7, wherein provided and/or additional adhesive and/or adhesive layers
are formed as multilayer films with the film as a vapor-and air-tight flow-tight layer in the middle and/or
are formed as cover layers and/or
are provided on the top cloth and on the nonwoven and/or
the adhesive/adhesive films are selected CoPET and EVA.

11. The insulation component according to claim 7, wherein the nonwoven has a total thickness of 4 to 60 mm.

12. The insulation component according to claim 7, wherein the nonwoven of the absorber layer
has a constant density of 10 to 130 g/l, and/or
over the length has areas with different densities in the density range from 20 g/l to 50 g/l.

13. The insulation component according to claim 7, wherein
one nonwoven side of the insulation component is be placed on a vehicle body, wherein this side is nubby or
the nonwoven insulation is structured on the body side.

14. The insulation component according to claim 7, wherein the nonwoven has a total thickness of 20 to 50 mm.

15. The insulation component according to claim 7, wherein the nonwoven of the absorber layer
has a constant density of between 20 and 50 g/l, and/or
over the length has areas with different densities in the density range from 20 g/l to 50 g/l.
